(19) United States
(12) Patent Application Publication
(10) Pub. No.: US 2026/0152125 A1
(43) Pub. Date: Jun. 4, 2026

(54) DISPLAY CONTROL DEVICE, DISPLAY CONTROL METHOD, AND STORAGE MEDIUM

(71) Applicant: TOYOTA JIDOSHA KABUSHIKI KAISHA, Toyota-shi (JP)

(72) Inventors: Miki TSUJINO, Ichinomiya-shi (JP); Nana Tajima, Kasugai-shi (JP); Alexandre Thomas Gentner, Nagoya-shi (JP)

(73) Assignee: TOYOTA JIDOSHA KABUSHIKI KAISHA, Toyota-shi (JP)

(21) Appl. No.: 19/393,844

(22) Filed: Nov. 19, 2025

(30) Foreign Application Priority Data
Nov. 29, 2024 (JP) 2024-208928

(51) Int. Cl. B60R 1/27

(52) U.S. Cl. CPC B60R 1/27; B60R 2300/607; B60R 2300/8033

(57) ABSTRACT

There is provided a display control device including a determination unit configured to determine an object present around a host vehicle by performing image processing on a captured image obtained by capturing surroundings of the host vehicle, and a display unit configured to display, when the object determined by the determination unit is a person, a person image corresponding to the person and a shadow image representing a shadow of the person on a bird's-eye view image obtained by viewing the host vehicle from above, together with a host vehicle image regarding the host vehicle, by disposing the person image and the shadow image at a position corresponding to a location of the person.

### CROSS-REFERENCE TO RELATED APPLICATION

This application claims priority to Japanese Patent Application No. 2024-208928 filed on Nov. 29, 2024. The disclosure of the above-identified application, including the specification, drawings, and claims, is incorporated by reference herein in its entirety.

### BACKGROUND

### 1. Technical Field

The present disclosure relates to a display control device, a display control method, and a storage medium.

### 2. Description of Related Art

A technique for more accurately determining a type of an object using a captured image is disclosed. For example, Japanese Unexamined Patent Application Publication No. 2017-054311 (JP 2017-054311 A) discloses an object detection device including an object detection unit, a temporary determination unit, a speed acquisition unit, and a final determination unit. The object detection unit detects a pedestrian or a two-wheeled vehicle as an object present around a host vehicle by performing image processing on a captured image obtained by capturing a traveling direction of the host vehicle. The temporary determination unit makes a temporary determination of the type of the object detected by the object detection unit by analyzing the captured image. The speed acquisition unit acquires a moving speed of the object by using a reflected wave of a carrier wave. The final determination unit determines the type of the object determined by the temporary determination unit by using the moving speed of the object acquired by the speed acquisition unit.

### SUMMARY

When an image corresponding to a determined object is displayed in a vehicle, the image may be displayed as a bird's-eye view image obtained by viewing the vehicle from above to simplify the display. In the case, when a person image corresponding to an object determined as the person is displayed directly at a position corresponding to a location of the person on the bird's-eye view image, there is a concern that the person may appear to be lying on a road.

The present disclosure has been made in view of the problems, and an object of the present disclosure is to provide a display control device, a display control method, and a storage medium that display a state of a person in a more easily understandable manner as compared with a case where a person image is displayed directly in the bird's-eye view image obtained by viewing the vehicle from above.

A display control device according to a first aspect of the present disclosure includes
a determination unit configured to determine an object present around a host vehicle by performing image processing on a captured image obtained by capturing surroundings of the host vehicle, and
a display unit configured to display, when the object determined by the determination unit is a person, a person image corresponding to the person and a shadow image representing a shadow of the person on a bird's-eye view image obtained by viewing the host vehicle from above, together with a host vehicle image regarding the host vehicle, by disposing the person image and the shadow image at a position corresponding to a location of the person.

The display control device according to a second aspect of the present disclosure is the display control device according to the first aspect,
in which the display unit is configured to display, when the object determined by the determination unit is a vehicle, a vehicle image corresponding to the vehicle in a bird's-eye view state on the bird's-eye view image at a position corresponding to a location of the vehicle.

The display control device according to a third aspect of the present disclosure is the display control device according to the first aspect,
in which the bird's-eye view image is an image related to an operation status of a system that supports a driving operation of the host vehicle.

There is provided a display control method according to a fourth aspect of the present disclosure, which causes a processor to execute the following process including determining an object present around a host vehicle by performing image processing on a captured image obtained by capturing surroundings of the host vehicle; and displaying, when the determined object is a person, a person image corresponding to the person and a shadow image representing a shadow of the person on a bird's-eye view image obtained by viewing the host vehicle from above, together with a host vehicle image regarding the host vehicle, by disposing the person image and the shadow image at a position corresponding to a location of the person.

There is provided a non-transitory storage medium storing a display control program according to a fifth aspect of the present disclosure, the display control program causes a computer to execute the following process including determining an object present around a host vehicle by performing image processing on a captured image obtained by capturing surroundings of the host vehicle, and displaying, when the determined object is a person, a person image corresponding to the person and a shadow image representing a shadow of the person on a bird's-eye view image obtained by viewing the host vehicle from above, together with a host vehicle image regarding the host vehicle, by disposing the person image and the shadow image at a position corresponding to a location of the person.

According to the present disclosure, it is possible to provide a display control device, a display control method, and a storage medium that display a state of a person in a more easily understandable manner as compared with a case where a person image is displayed directly in the bird's-eye view image obtained by viewing the vehicle from above.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a hardware configuration example of a vehicle according to an embodiment of the technique of the disclosure;

FIG. 2 is a block diagram showing an example of a functional configuration of the ECU;

FIG. 3 is a diagram showing a display example of the bird's-eye view image on a monitor by the display unit;

FIG. 4 is a diagram showing a display example of the bird's-eye view image on the monitor by the display unit; and

FIG. 5 is a flowchart showing a flow of a display control process by the ECU.

### DETAILED DESCRIPTION OF EMBODIMENTS

Hereinafter, an example of an embodiment of the present disclosure will be described with reference to the drawings. In addition, the same or equivalent components and portions in each drawing are denoted by the same reference numerals. Further, the proportions of the dimensions in the drawings are exaggerated for the sake of description and may be different from the actual proportions.

An embodiment of the present disclosure relates to a display control device that controls display of an image displayed in a vehicle cabin of a vehicle. Specifically, the embodiment of the present disclosure relates to a display control device that determines an object included in an image from an image captured by a camera provided in a vehicle and controls a display of the determined object in a bird's-eye view image obtained by viewing an image of the vehicle from above.

When the image corresponding to the determined object is displayed in the vehicle, the image may be displayed as a bird's-eye view image obtained by viewing the vehicle from above in order to simplify the display. In the case, when the person image corresponding to the object determined as the person is displayed, in a case where the person image is displayed directly at a position corresponding to the location of the person on the bird's-eye view image, there is a concern that the person may appear to be lying on the road. There is also a method of displaying the person image on the upper body alone on the bird's-eye view image, but in that case, the person appears to be buried in the road.

In the present embodiment, when the bird's-eye view image is displayed, the person image corresponding to the object determined as the person is displayed with a predetermined angle. By displaying the person image corresponding to the object determined as the person with a predetermined angle, the state of the person can be displayed in a more easily understandable manner as compared with a case where the person image is displayed directly.

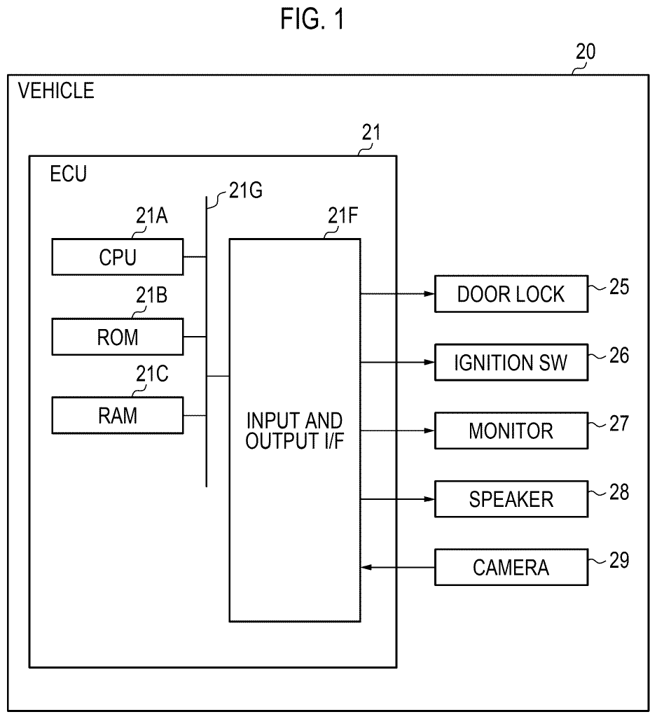

FIG. 1 is a diagram showing a hardware configuration example of a vehicle 20. As shown in FIG. 1, the vehicle 20 according to the present embodiment is configured to include an ECU 21. The ECU 21 is an example of a display control device of the present disclosure. The vehicle 20 further includes a door lock 25, an ignition switch (SW) 26, a monitor 27, a speaker 28, and a camera 29.

The ECU 21 is configured to include a central processing unit (CPU) 21A, a read only memory (ROM) 21B, a random access memory (RAM) 21C, and an input and output I/F 21F. The CPU 21A, the ROM 21B, the RAM 21C, and the input and output I/F 21F are connected to each other to be able to communicate with each other through an internal bus 21H.

The CPU 21A is a central arithmetic processing unit that executes various programs and controls each part. That is, the CPU 21A reads the program from the ROM 21B and executes the program using the RAM 21C as a work area.

The ROM 21B stores various programs and various data. The ROM 21B of the present embodiment stores a computer program for controlling the ECU 21. In the present embodiment, a display control program that controls display of an image on the monitor 27 is stored in the ROM 21B.

The RAM 21C temporarily stores a program or data as a work area.

The input and output I/F 21F is an interface for communicating with the door lock 25, the ignition SW 26, the monitor 27, and the speaker 28 mounted on the vehicle 20.

The door lock 25 is a key of a door of the vehicle 20, and is opened and closed by a user who gets on the vehicle 20, and is controlled to be opened and closed by the CPU 21A.

The ignition SW 26 is a switch that starts the engine of the vehicle 20, and is turned on and off by the user who gets on the vehicle 20, and is turned on and off by the CPU 21A.

The monitor 27 is a liquid crystal monitor provided in an instrument panel, a meter panel, or the like, and displays an image regarding the current position, the traveling route, and the caution information. The monitor 27 may be provided with a touch panel that also serves as a switch for inputting an operation by the hand of the occupant.

The speaker 28 is provided in an instrument panel, a center console, a front pillar, a dashboard, or the like, and is a device for outputting a voice.

The camera 29 captures surroundings of the vehicle 20 and outputs the captured image to the ECU 21. The number of the cameras 29 may be one or a plurality.

In FIG. 1, the configuration is such that one ECU 21 controls each device of the vehicle 20, but the present disclosure is not limited to such an example. For example, the ECU that controls the door lock 25 and the ECU that controls the ignition SW 26 may be separate ECUs.

When the display control program is executed, the ECU 21 realizes various functions by using the hardware resources. A functional configuration realized by the ECU 21 will be described.

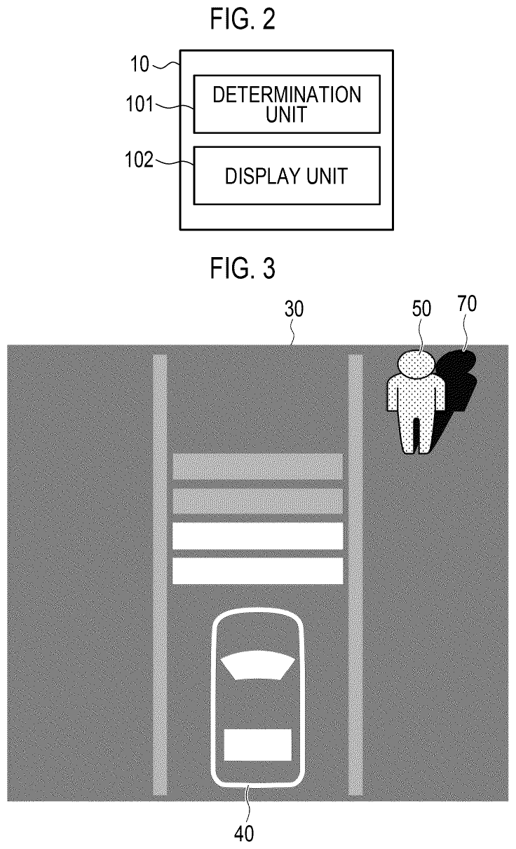

FIG. 2 is a block diagram showing an example of a functional configuration of the ECU 21.

As shown in FIG. 2, the ECU 21 has a determination unit 101 and a display unit 102 as a functional configuration. The CPU 21A reads and executes a display control program stored in the ROM 21B to realize each functional configuration.

The determination unit 101 determines the object present around the vehicle 20 by performing image processing on the captured image captured by the camera 29 around the vehicle 20. The timing of acquiring the captured image from the camera 29 is optional. The object determined by the determination unit 101 is a human, a vehicle, or the like. The determination method of the object by the determination unit 101 is optional, but for example, the object present around the vehicle 20 is determined based on whether the object to be determined is included in the captured image.

The display unit 102 displays a bird's-eye view image schematically showing the appearance of the vehicle 20 as viewed from above, on the monitor 27. The display unit 102 displays the image of the object determined by the determination unit 101 on the bird's-eye view image by disposing the image at a position corresponding to the location of the object when displaying the bird's-eye view image on the monitor 27. Here, when the display unit 102 displays, on the bird's-eye view image, an object determined by the determination unit 101 by disposing the object at a position corresponding to a location of the object, the display unit 102 displays, in a case where the object is a person, a person image corresponding to the person as an image of the object. The person image is, for example, an image in which a human shape is imitated. Then, the display unit 102 displays the person image in a state of being tilted by a predetermined amount when displaying the person image on the bird's-eye view image, and displays a shadow image indicating a shadow of the person on the person image to indicate that the person is standing on the road. The display of the person image in the tilted state by the predetermined amount refers to the display of the person image in the tilted state from the state in which the person image is directly (appears to be lying down) in the bird's-eye view image.

When the object determined by the determination unit 101 is an object other than a person, for example, a vehicle, the vehicle image corresponding to the vehicle is displayed as the image of the object. Then, when the display unit 102 displays the vehicle image on the bird's-eye view image, the vehicle displays the bird's-eye view image by disposing the vehicle image in a state of viewing the vehicle from above.

FIG. 3 is a diagram showing a display example of the bird's-eye view image on the monitor 27 by the display unit 102. A bird's-eye view image 30 shown in FIG. 3 includes a vehicle image 40 showing the vehicle 20 as the host vehicle and a person image 50 showing the person. The vehicle image 40 is an example of a host vehicle image of the present disclosure. Then, the display unit 102 displays the vehicle image 40 on the bird's-eye view image 30 in a bird's-eye view state, and displays the person image 50 on the bird's-eye view image 30 in a state of being inclined obliquely. In addition, the display unit 102 visually indicates that the person image 50 is in the obliquely inclined state by displaying the bird's-eye view image 30 with a shadow image 70 added to the person image 50 in order to indicate that the person is standing on the road.

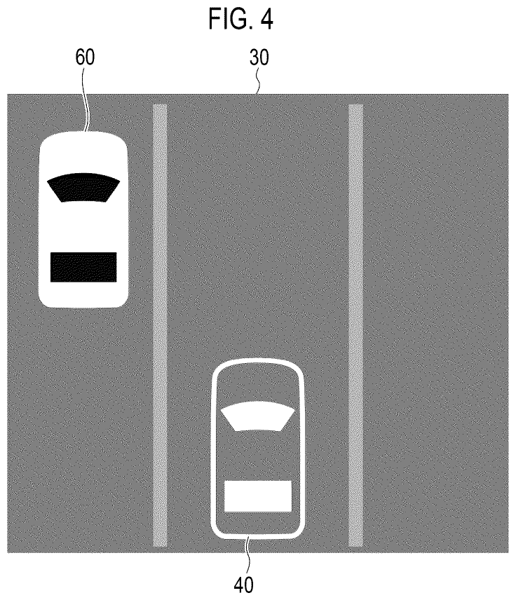

FIG. 4 is a diagram showing a display example of the bird's-eye view image on the monitor 27 by the display unit 102. The bird's-eye view image 30 shown in FIG. 4 includes the vehicle image 40 showing the vehicle 20 that is the host vehicle and a vehicle image 60 showing the oncoming vehicle. The display unit 102 displays the vehicle image 40 and the vehicle image 60 on the bird's-eye view image 30 in a bird's-eye view state.

As described above, when the bird's-eye view image is displayed on the monitor 27, the person image is displayed in a state of being tilted by a predetermined amount, and the shadow image representing the shadow of the person is displayed together with the person image. As a result, the display unit 102 can display the state of the person in a more easily understandable manner as compared with a case where the person image is displayed directly in the bird's-eye view image obtained by viewing the vehicle from above.

The display unit 102 may decide whether to display the person image in a state of being tilted by a predetermined amount or to display in a state of not being tilted, based on a setting as to whether to tilt and display the person image when displaying the bird's-eye view image on the monitor 27. Further, the display unit 102 may decide the degree of inclination of the person image based on the setting of the inclination angle when the person image is inclined and displayed when the bird's-eye view image is displayed on the monitor 27. The display unit 102 may change the size of the shadow image according to the set inclination angle.

In addition, when the display unit 102 displays the bird's-eye view image on the monitor 27, in a case where the determination unit 101 can determine the moving direction of the object determined as the person and the moving direction or the speed may be added to the person image as an arrow or an effect indicating the moving direction or the speed. By adding an arrow or an effect indicating a moving direction or a moving speed to the person image, the driver can intuitively understand the movement of the person.

In addition, the display unit 102 may dynamically adjust the inclination amount of the person image according to the distance or positional relationship between the vehicle 20 that is the host vehicle and the person. Specifically, the display unit 102 may increase the inclination amount of the person image as the distance between the vehicle 20 that is the host vehicle and the person becomes shorter, and may decrease the inclination amount of the person image as the distance between the vehicle 20 and the person becomes longer. Then, the display unit 102 may change the size of the shadow image according to the amount of inclination.

In addition, the display unit 102 may dynamically adjust the size of the person image according to the distance or positional relationship between the vehicle 20 that is the host vehicle and the person. Specifically, the display unit 102 may enlarge the person image as the distance between the vehicle 20 that is the host vehicle and the person becomes closer, and may reduce the person image as the distance between the vehicle 20 and the person becomes farther. Then, the display unit 102 may change the size of the shadow image in accordance with the size of the person image.

Next, the operation of the ECU 21 will be described.

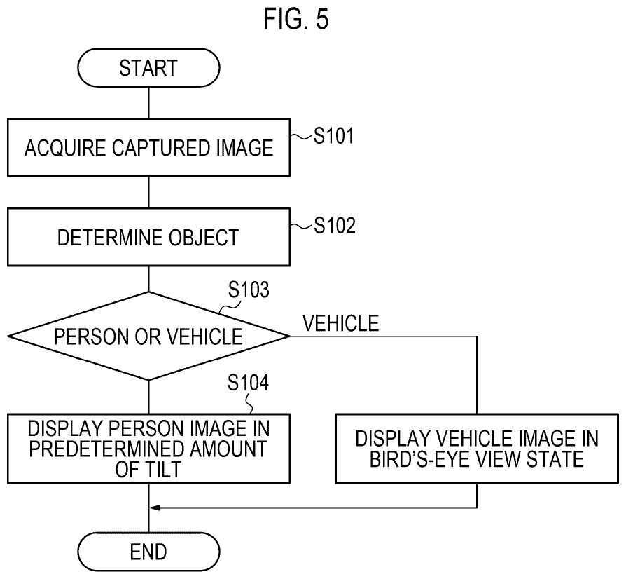

FIG. 5 is a flowchart showing a flow of a display control process by the ECU 21. The CPU 21A reads out and executes the display control program stored in the ROM 21B to perform the display control processing.

The CPU 21A acquires the captured image in which the camera 29 captures the surroundings of the vehicle 20 in S101. The acquisition timing of the captured image is optional.

Subsequently to S101, the CPU 21A performs image processing on the captured image in S102 to determine the object present around the vehicle 20. The object determined by the CPU 21A is a human, a vehicle, or the like. The determination method of the object by the CPU 21A is optional, but for example, the object present around the vehicle 20 is determined based on whether the determination target object is included in the captured image.

Subsequently to S102, the CPU 21A determines in S103 whether the object determined in S102 is a person or a vehicle.

As a result of the determination in S103, when the object determined in S102 is a person, the CPU 21A disposes the person image corresponding to the person in a state of being tilted by a predetermined amount on the bird's-eye view image schematically showing the appearance of the vehicle 20 viewed from above in S104. Further, the CPU 21A adds the shadow image to the person image to indicate that the person is standing on the road, and displays the bird's-eye view image on the monitor 27.

As a result of the determination in S103, when the object determined in S102 is the vehicle, the CPU 21A displays the bird's-eye view image on the monitor 27 by disposing the vehicle image in a bird's-eye view state of viewing the vehicle from above, the vehicle image corresponding to the vehicle in the bird's-eye view state of the vehicle on the bird's-eye view image schematically showing the appearance of the vehicle 20 viewed from above in S105.

As described above, when the bird's-eye view image is displayed on the monitor 27, the person image is displayed in the state of being tilted by the predetermined amount, whereby the CPU 21A can display the state of the person in a more easily understandable manner as compared with a case where the person image is displayed directly in the bird's-eye view image obtained by viewing the vehicle from above.

Although the embodiments of the present disclosure have been described in detail with reference to the accompanying drawings, the technical scope of the present disclosure is not limited to the examples. The embodiment described above is exemplary and does not limit the technical scope of the present disclosure. One skilled in the art will appreciate that various modifications or correction examples can be conceived within the scope of the technical thought described in the claims by one skilled in the art in the technical field of the present disclosure. Further, it is naturally understood that the modification or the correction examples also belong to the technical scope of the present disclosure.

Further, the effects described in the embodiment are illustrative or exemplary, and are not limited to the effects described in the embodiment. That is, the technique according to the present disclosure can achieve another effect that is apparent to one skilled in the art of the present disclosure from the description in the embodiment, together with or instead of the effects described in the embodiment.

Note that various processors other than the CPU may execute the display control processing that is read and executed by the CPU as software (program) in each of the embodiments. Examples of the processor in the case include a programmable logic device (PLD), such as a field-programmable gate array (FPGA) that can change a circuit configuration after manufacturing, and a processor having a circuit configuration designed for executing a specific process, such as an application specific integrated circuit (ASIC). Further, the display control processing may be executed by one of the various processors, or may be executed by a combination of two or more processors of the same kind or different kinds (for example, a plurality of FPGAs, and a combination of a CPU and an FPGA). In addition, the hardware structure of the various processors is more specifically an electrical circuit in which circuit elements, such as semiconductor elements, are combined.

In addition, in each of the embodiments, the aspect has been described in which the program of the display control process is stored (installed) in the ROM or the storage in advance, but the present disclosure is not limited thereto. The program may be provided in a form recorded on a non-transitory recording medium (storage medium), such as a compact disk read only memory (CD-ROM), a digital versatile disk read only memory (DVD-ROM), or a universal serial bus (USB) memory. Further, the program may be downloaded from an external device via a network. In addition, the present disclosure may be applied to a program product.

What is claimed is:

1. A display control device comprising:
a determination unit configured to determine an object present around a host vehicle by performing image processing on a captured image obtained by capturing surroundings of the host vehicle; and
a display unit configured to display, when the object determined by the determination unit is a person, a person image corresponding to the person and a shadow image representing a shadow of the person on a bird's-eye view image obtained by viewing the host vehicle from above, together with a host vehicle image regarding the host vehicle, by disposing the person image and the shadow image at a position corresponding to a location of the person.

2. The display control device according to claim 1, wherein the display unit is configured to display, when the object determined by the determination unit is a vehicle, a vehicle image corresponding to the vehicle in a bird's-eye view state on the bird's-eye view image at a position corresponding to a location of the vehicle.

3. The display control device according to claim 1, wherein the bird's-eye view image is an image related to an operation status of a system that supports a driving operation of the host vehicle.

4. A display control method that causes a processor to execute the following process comprising:
determining an object present around a host vehicle by performing image processing on a captured image obtained by capturing surroundings of the host vehicle; and
displaying, when the determined object is a person, a person image corresponding to the person and a shadow image representing a shadow of the person on a bird's-eye view image obtained by viewing the host vehicle from above, together with a host vehicle image regarding the host vehicle, by disposing the person image and the shadow image at a position corresponding to a location of the person.

5. A non-transitory storage medium storing a display control program that causes a computer to execute the following process comprising:
determining an object present around a host vehicle by performing image processing on a captured image obtained by capturing surroundings of the host vehicle; and
displaying, when the determined object is a person, a person image corresponding to the person and a shadow image representing a shadow of the person on a bird's-eye view image obtained by viewing the host vehicle from above, together with a host vehicle image regarding the host vehicle, by disposing the person image and the shadow image at a position corresponding to a location of the person.
